(19) United States
(12) Patent Application Publication
(10) Pub. No.: US 2019/0139069 A1
(43) Pub. Date: May 9, 2019

(54) CROWDSOURCED MARKETPLACE WITH REWARDS

(71) Applicant: Haramol Singh Sandhu, McLean, VA (US)

(72) Inventor: Haramol Singh Sandhu, McLean, VA (US)

(21) Appl. No.: 16/153,716

(22) Filed: Oct. 6, 2018

Related U.S. Application Data
(60) Provisional application No. 62/581,674, filed on Nov. 4, 2017.

(51) Int. Cl. G06Q 30/02

(52) U.S. Cl. CPC G06Q 30/0214; G06Q 30/0239; G06Q 30/0215

(57) ABSTRACT

One embodiment provides for a bounty to the crowd to facilitate the purchasing of quality services or goods or mixed goods and services by a service buyer, goods buyer, or requester. The embodiment harnesses the wisdom of the crowd, with the crowd incentivized by receiving some or all of a share of a bounty for vouching for or ensuring an applicant, individual, proposal, bid, product, or provider in order to rank such applicants, individuals, proposals, bids, products, or providers. In this embodiment, both the bounty and the vouch or surety payment represent actual value, in the form of currency, crypto-currency, or another item of value. Furthermore, in this embodiment, applicants, individuals, proposals, bids, products, or providers are ranked according to the total amount of surety payments (vouch payments) provided by recommenders. Other embodiments are described and shown.

### CROSS REFERENCE TO RELATED APPLICATION

This application claims priority under 35 U.S.C. § 119(e) of U.S. Provisional Application 62/581,674, filed Nov. 4, 2017, the entire contents of which are hereby incorporated by reference.

### FIELD OF THE INVENTION

The present invention relates to the connecting of buyers with sellers of goods or services. More specifically, the present invention relates generally to connecting via the Internet or other network of service buyers with service providers, jobs with candidates, and buyers of goods with goods.

### BACKGROUND

There are a number of methods whereby potential buyers of services can be connected with service providers via the Internet. For example, search engines are sometimes used to help service buyers find service providers to provide the desired services. In addition, a number of websites specifically provide for listings of service providers/professionals (such as, for example, linkedin.com). Still other websites provide for projects and the matching of service buyers and service providers (such as, for example, upwork.com, taskrabbit, and gocatalant.com), with many of these websites also providing for the rating of service provider performance upon project completion. Similarly, there are a number of online platforms connecting of jobs and candidates, and buyers and sellers of goods. In addition, a number of social networks like Facebook allow individuals to request recommendations from their networks.

Current websites provide inadequate information to buyers as to the general competency of a service provider or job candidate, and even less adequate information as to whether the service provider's skills and competency are a good fit for the particular project or job for which the buyer is hiring. As a result, the matching of service providers and service buyers (and candidates and jobs) has remained inefficient, even with the proliferation of websites that attempt to match service buyers and service providers (and candidates and jobs). This continuing inefficiency is in contrast to the market for homogeneous goods, as online marketplaces connecting consumers with goods have generally increased efficiency in the market for such goods. A large factor in this discrepancy is due to the heterogeneous nature of services and service providers, as compared to many goods. Current service provider ratings methodologies often rely primarily on limited project ratings given by past service buyers of the service provider's services. Importantly, these ratings may be with respect to projects that, while in broadly the same field for which services are requested on the project at issue, required different competencies than the particular project. Furthermore, because in many cases these ratings are only provided upon project completion, if at all, and because the ratings under these websites are primarily only given by a limited number of service buyers, who may not be as familiar with the range of competency of service providers in the field, the resulting aggregate and average ratings data with respect to many service providers is often not very robust nor very informative to future service buyers. Similarly, for longer-term jobs, traditional marketplaces provide limited information about the competency of an applicant for a particular unique job opening, thereby requiring that considerable vetting be done by the hiring party. Even with respect to the market for goods and mixed goods and services, inefficiencies remain, especially with respect to goods or mixed goods and services that are heterogeneous. Existing marketplaces often do not provide sufficient useful actionable information to the buyer looking for the right service provider or good to satisfy the buyer's specific needs. Furthermore, in many cases the best service providers for a project or job may not even know about a project or job opening, let alone apply for project or job. While traditional methodologies like referral bonuses can encourage applications, the effect is limited and does not harness collective wisdom. And even where referrals are possible, most methodologies do not provide sufficiently useful information to usefully rank the various candidates, providers, or bids.

### SUMMARY

One or more embodiments described herein provide benefits and/or solve one or more of the foregoing or other problems in the art with systems and methods to enable service buyers to hire qualified service provider(s) for a job or project, or goods buyers to find goods matching their needs. In one or more embodiments, the system harnesses the collective wisdom of the crowd, incentivized by monetary rewards (or other rewards of value), in order to provide useful information to a buyer of services or goods (or agent of such buyer) as to the best proposals, bids, candidates, providers, or product submissions pursuant to a request for proposal (RFP), provider request, product request, recommendation request, or project, job, product opening or listing posted by that buyer on a website or other marketplace. Among other benefits, one or more embodiments of the system produce a better system for ranking bids, candidates, providers, or products for such an opening or listing.

Additional features and advantages of the embodiments will be set forth in the description that follows, and in part will be obvious from the description, or can be learned by the practice of such exemplary embodiments. The features and advantages of such embodiments can be realized and obtained by means of the instruments and combinations particularly pointed out in the appended claims. These and other features will become more fully apparent from the following description and appended claims, or can be learned by the practice of such exemplary embodiments as set forth hereinafter.

### BRIEF DESCRIPTION OF THE DRAWINGS

Non-limiting and non-exhaustive embodiments of the invention are described, in part, with reference to FIG. 1, which is an exemplary flow chart showing the steps taken with respect to a project/job in one or more embodiments.

FIG. 2 illustrates an exemplary portion of a project page in one or more embodiments.

FIG. 3 illustrates an exemplary portion of one application listing on a portion of a project page in one or more embodiments.

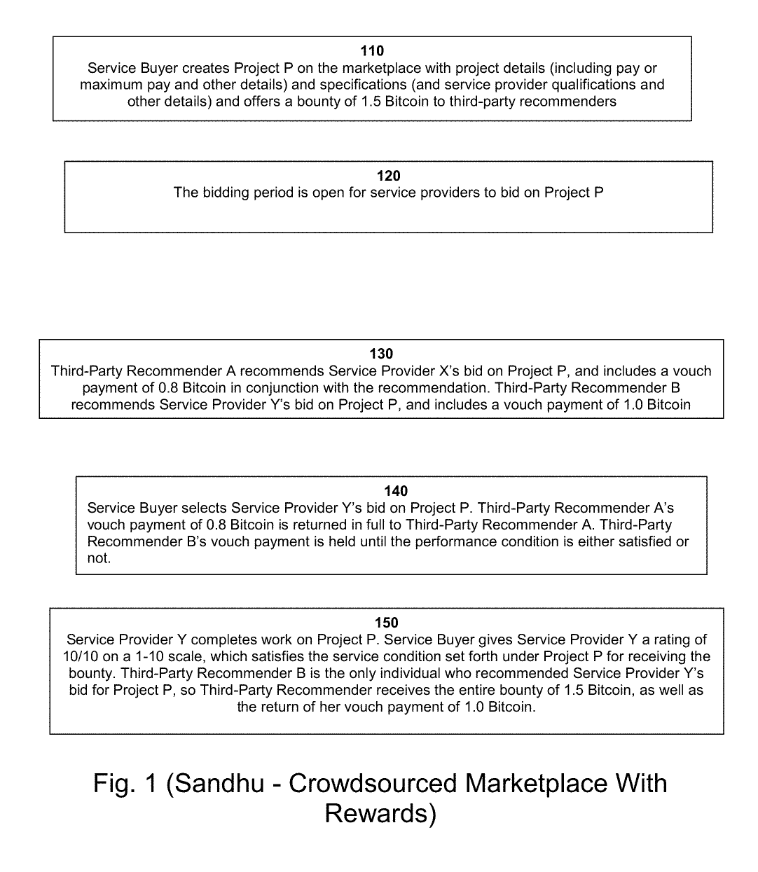

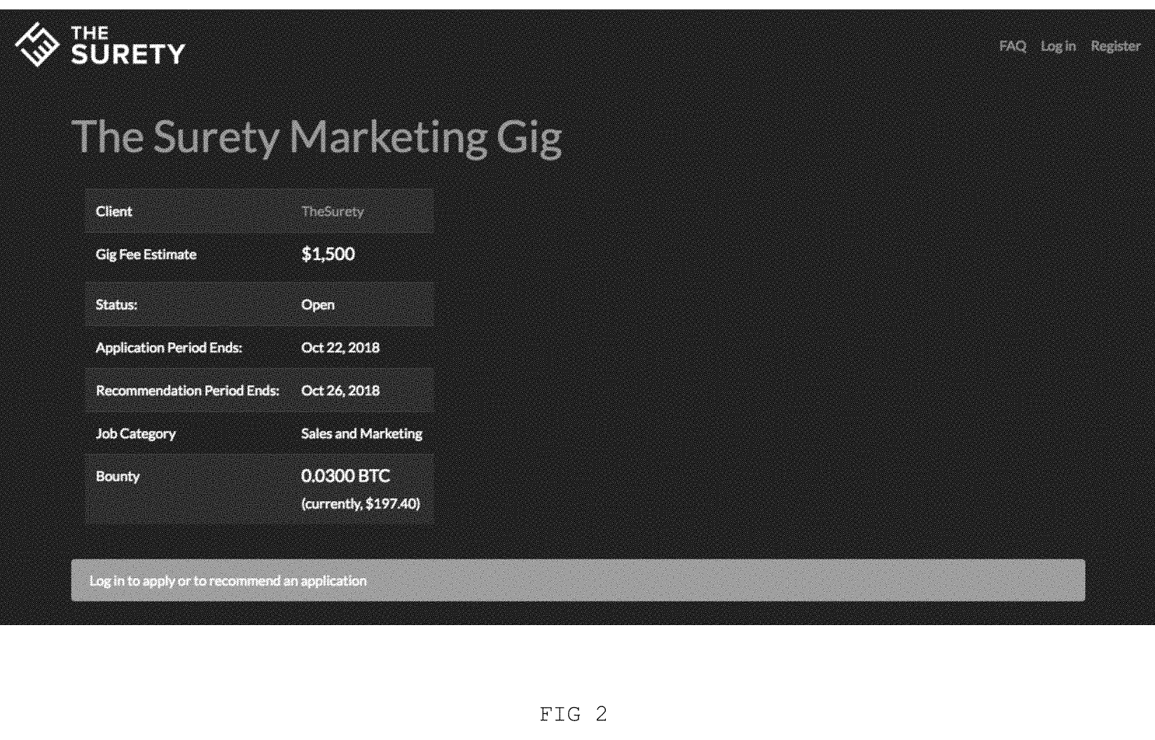

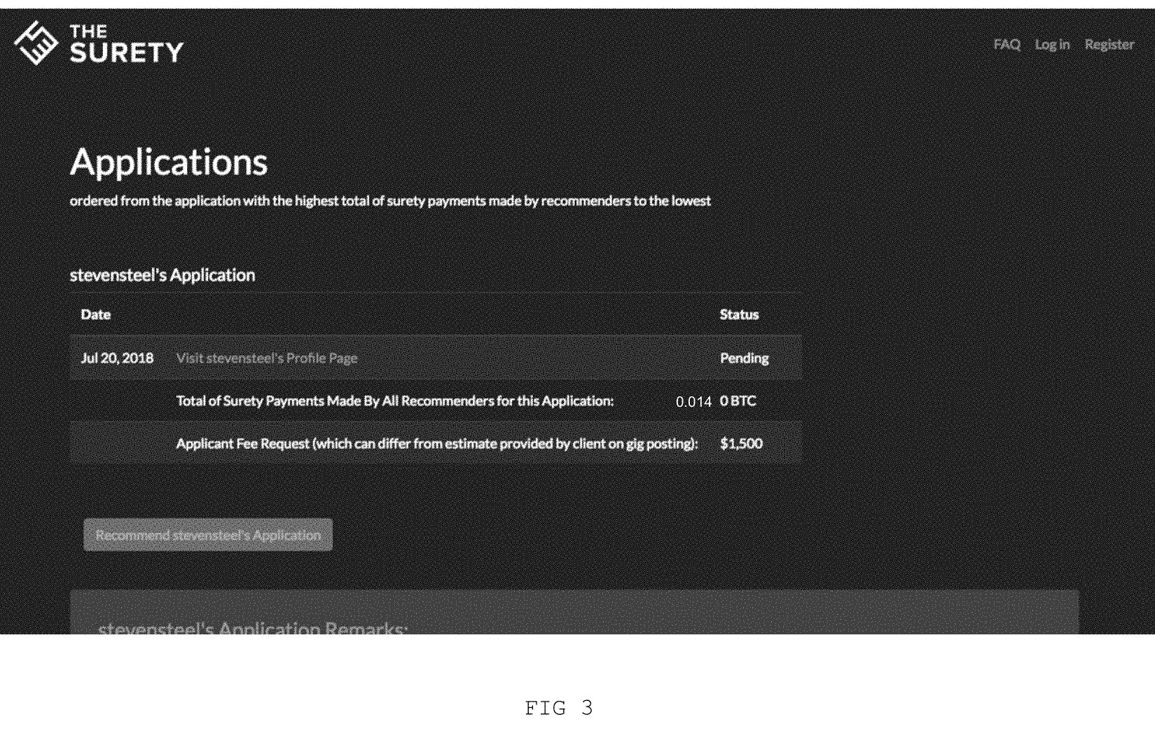

### DETAILED DESCRIPTION

This document describes a system and method for facilitating the purchasing by a buyer of services or goods (or agent of such buyer) of quality services or goods pursuant to a request for proposal (RFP), product request, provider request, recommendation request, or project or job listing posted by that buyer on a website or other marketplace. The system and method also provides for a system to rank proposals, applications, candidates, providers, or products that have submitted bids, offers, or similar expressions of interest pursuant to the RFP, product request, provider request, recommendation request, or project or job listing (or even potential providers or products that have yet to express interest). In the following description, numerous specific details are set forth to provide a thorough understanding of the embodiments. One skilled in the relevant art will recognize, however, that the techniques described herein can be practiced without one or more of the specific details, or with other methods or details. In other instances, well-known operations are not shown or described in detail to avoid obscuring certain aspects. For example, details relating to networks, such as the Internet generally and more specifically common methods and processes used in websites connecting service buyers and service providers and jobs and candidates, details included in websites with profiles of service providers, details regarding information traditionally included in response to a request for proposal, search engine processes, processes related to accessing a database of service provider/candidate profiles, features of social networks, and features of marketplaces connecting buyers and sellers of goods or products generally are not described in detail herein.

Reference throughout this specification to “one embodiment” or similar terminology means that a particular feature, structure, or characteristic described in connection with the embodiment is included in at least one embodiment of the present invention. Thus, the appearances of the phrase “in one embodiment” or similar terminology in various places throughout this specification are not necessarily all referring to the same embodiment, and alternative embodiments are not meant to be mutually exclusive. Furthermore, particular features or characteristics described herein may be combined, in whole or in part, in any suitable manner in one or more embodiments and not all combinations of different features or characteristics of the invention are set forth in this specification. Furthermore, the use of terms such as “or” are not meant to be mutually exclusive in all embodiments, and different features can be combined, in whole or in part, in different embodiments.

In connection with a job posting, project posting, RFP, recommendation request, or similar solicitation, it is contemplated that the system would include a feature whereby a bounty is offered, which is a monetary amount or other amount of value to be split or otherwise rewarded to one or more individuals (or groups of individuals) who recommend particular proposals, bids, bidders, applicants, products, or candidates for the listing, opening, posting, RFP, or request 110 For example, in one or more embodiments, bitcoin or other cryptocurrency could be offered as a bounty by the service buyer. In other embodiments, traditional currency can be used. In some embodiments, the bounty could be any amount selected by the service buyer. In some embodiments, the bounty could be a percentage of the project cost, or some other methodology could be used to set the bounty. In some embodiments, there could be minimum or maximum bounty amounts.

In one or more embodiments, recommenders can recommend one or more candidates or bids that have been submitted in connection with the project or job listing. In one or more embodiments, it is contemplated that a recommender would only receive some or all of the bounty for a particular project if the service buyer selects the bid or candidate recommended by the recommender and some other criteria measuring service provider performance is satisfied. In one or more embodiments, that other criterion is that the service buyer rates the service provider's performance on the project (after project completion) above a certain threshold level. For example, in one or more embodiments, a recommender would only receive a share of the bounty if the recommender recommended the bid selected by the service buyer and the service buyer rated the service provider's performance either a 9 out of 10 or a 10 out of 10 on a 1-10 scale of service provider performance on the project. It is contemplated that, in some embodiments, recommenders would be able to recommend more than one bid and rank them. In one or more embodiments, recommenders would receive a greater share of the bounty if the bid selected was the highest rated bid and the service provider performance exceeded the threshold. In some embodiments, the marketplace may receive a percentage of the bounty amounts, with the remainder distributed to recommenders. Various ratings methodologies could be used under different embodiments. It is also contemplated that various methodologies could be used to determine a recommender's share of the bounty. For example, in some embodiments, all recommenders who satisfy the criteria for receiving a bounty would split the bounty. In other embodiments, one or more recommenders may receive a greater share of the bounty or even all of the bounty if certain criteria are met.

In the preferred and other embodiments, in conjunction with a recommendation of a bid for a project or candidate for a job, a recommender would pay an amount of value (vouch payment or surety payment). In one or more embodiments, the vouch payment could be any amount specified by the recommender. In some embodiments, there may be a minimum or maximum vouch payment. In some embodiments, if the bid or candidate for which a vouch payment is made is not selected by the service buyer, then the vouch payment would be returned, in whole or in part, to the recommender. In one or more embodiments, if the vouch payment is connected to the chosen bid or candidate, then such vouch payment (together with all other vouch payments made by other recommendations connected with that bid or candidate) will be held until the performance condition for receiving the bounty is either met or not met. In the preferred embodiment, if the condition for receiving the bounty related to service provider performance is met, it is contemplated that the bounty (potentially less some commission charged by the marketplace or other fees) will be disbursed to each recommender who recommended the bid or candidate in proportion to the amount of the recommender's vouch payment is in proportion to the total vouch payments of all recommenders for that bid or candidate. In such a case, in one or more embodiments, each recommender of that bid or candidate would also get some or all of their vouch payment back (potentially less some commission or other fees). In one or more embodiments, if the condition for receiving the bounty is not satisfied, then it is contemplated that some or all of the vouch payments and the bounty will be otherwise disbursed in the marketplace or otherwise. In one or more embodiments, it is contemplated that recommenders can recommend and pay vouch payments (potentially of differing amounts) for more than one bid or candidate for a particular project or job. In some embodiments, some or all of the vouch payments may replace the bounty offered by the service buyer, so that some or all of the amount to be distributed upon satisfaction of the service condition to receive the bounty consists partially or entirely of vouch payments for that project or job (or a subset of such vouch payments) or unrewarded vouch payments from other projects or jobs. In some embodiments, the vouch payments may replace or offset, in whole or in part, other amounts such as the fees or compensation paid to the service provider by the service buyer. In some embodiments, not all recommenders who satisfy the criteria for receiving the bounty may share in the bounty equally or in proportion to the amount of their vouch payments. Other criteria may be used to determine the relative share received of the bounty by a recommender. For example, in one or more embodiments, the recommender who satisfies the criteria for receiving the bounty and who has the greatest vouch payment on the winning bid would receive a disproportionate share, or potentially even the entire bounty.

In some embodiments, the proportion of the bounty received and/or proportion of vouch payments returned to a recommender could depend, in whole or in part, on the relative value of service performance or some other metric. For example, a recommender could have their vouch payment returned in full for a rating of 9/10 or 10/10 on a 1-10 scale, but only 90% returned for a rating of 8/10.

It is contemplated that, in some embodiments, the number of recommenders for a project could be limited, depending on certain factors such as, for example, the total dollar amount of the bounty. In some embodiments, there would be no limit on the number of recommenders. It is contemplated that in some embodiments the system would use methodologies to ensure that the recommenders are independent of the recommended bids or candidates as well as the service buyer, such as penalties and legal actions for collusion and other non-independence or gaming of the system. In the preferred embodiment, the recommenders for a job or product could not be a buyer or seller with respect to the particular job or project, but could otherwise know or be friends with the buyer or seller. In one or more embodiments, it would be possible for a service provider or candidate to vouch for their own bids or applications. In one or more embodiments, individuals could ask their social networks for a recommendation. In one or more embodiments, recommenders can recommend candidates or recommend that individuals bid who are not yet on the marketplace or who have not yet placed a bid for the job or project. In one or more embodiments, recommenders can only recommend candidates, proposals, bids, products, or applications that have already been placed/submitted.

In one or more embodiments, it is also contemplated that, if either there are no recommendations by recommenders for the selected bid or candidate or if the rating of the service provider's performance made by the service buyer after project completion does not meet the threshold to distribute the bounty to recommenders, then the amount of the bounty would, in whole or in part, be otherwise distributed. For example, the unrewarded bounty amounts for a project could be distributed to all projects throughout the marketplace for which the recommendation period has not closed or be distributed to some other subset of projects. In some embodiments, for example, unrewarded bounty amounts could be disbursed among other projects on the marketplace based on the size of the bounty for each of these other projects. For example, assuming there are only two projects for which the recommendation period has not closed and one has an existing bounty of $4000 and the other has an existing bounty of $1000, an unrewarded bounty of $2000 might get disbursed such that the project with the existing bounty of $4000 would get $1600 of the unrewarded bounty amount (so that the total bounty on that project would now be $5600) while the project with the existing bounty of $1000 would get $400 (so that the total bounty on that project would now be $1400). In some embodiments, other methodologies may be used to distribute unrewarded bounty amounts, such as distributing such amounts to service providers who have conducted the most business through the marketplace and/or received the highest ratings over a specified period. In one or more embodiments, if the project is not completed at all such that no payment is made to the service provider from the service buyer or the project is otherwise substantially incomplete (rather than performance merely not meeting a threshold level), then it is contemplated that the bounty would be returned back to the service buyer. In some embodiments, other criteria may be used to determine whether the undistributed bounty amount is disbursed otherwise in the market (in whole or in part), returned to the service buyer (in whole or in part), or potentially held by the marketplace or otherwise, or a combination of these methods is used. In one or more embodiments, if there are no recommendations or vouch payments for the selected bid, the bounty could be returned, in whole or in part, to the buyer.

In one or more embodiments, it is contemplated that there would be an initial bid period which will remain open for service providers to bid on a service buyer's project (and during this period, third parties could contact individuals both on and off the marketplace to encourage them to bid on the project). 120 In some embodiments, upon conclusion of that period, there would be a recommendation period for individuals to recommend one or more bids (and include vouch payments in conjunction with recommendations in some embodiments). 130 In some embodiments, the recommenders would have access to some or all of the bounty information, such as total bounty amount, number of bids, number of recommendations currently made, total vouch payments per bid, individual vouch amounts, or other such information. However, in some embodiments, recommenders would not have access to which bids or candidates had received the most recommendations from other recommenders. In one or more embodiments, after the recommendation period has closed, the service buyer would select the winning bid or bids (or candidate(s)). 140 After work is done, in one or more embodiments, the service buyer would rate the service provider's performance, upon which the bounty would either be distributed to be split among the recommenders who meet the criteria to receive the bounty or otherwise distributed if the criteria to receive the bounty on that project is not met. 150 In other embodiments, some or all of the periods outlined in this paragraph could overlap or otherwise be modified.

In some embodiments, it is contemplated that during the period when the service buyer can select the winning bid, the service buyer would have access to aggregate ratings data provided by the recommenders as to the best bids on the project, but potentially not access to the recommenders' identity for each individual bid and/or vouch payment. However, in some embodiments some or all of such information might be available. In one or more embodiments, it is also contemplated that the service buyer will have access to the total vouch payments made for each bid or candidate for the particular project or job as well as potentially such information and bounties paid/not paid on past projects or jobs. In one or more embodiments, the information on total vouch payments for each bid or candidate may be available to all individuals on the marketplace (or a subset of such individuals) throughout the duration of the listing period. In one or more embodiments, the bids or candidates for the current project or job could be ordered by from highest to lowest total dollar amount vouched and/or number of recommendations. In the preferred embodiment, the bids or candidates would be ordered from highest to lowest total vouch payments. In one or more embodiments, an aggregate score could be provided based on all the recommendations that ranks the bids, or other quantitative or qualitative data could be provided or analyzed based on the recommendations and/or vouch payments, as well as past vouch and bounty payments. In one or more embodiments, the recommenders may be able to include other information in addition to their recommendations and vouch payment, such as, for example, a narrative describing why they recommend the particular bid, which could be viewable by the service buyer (and/or potentially other individuals or subsets of individuals on the marketplace in some embodiments).

In one or more embodiments, multiple service provider bids or applications could be accepted for a project. In some embodiments, in such a case, there would in effect be separate bounties for each bid or application or other means of splitting the overall bounty would be used. In one or more embodiments, rather than the service buyer choosing which bid to accept, the system could provide that the marketplace or some other party has the ability to choose, acting as an agent of the service buyer.

In one or more embodiments, vouch payments and/or bounties may not represent actual currency, cryptocurrency, or another item of value outside the marketplace but rather tokens or other items with value only on the marketplace. In some embodiments, the tokens may be limited per recommender, limited throughout the marketplace, limited for a project or job, or otherwise. In one or more embodiments, these tokens could be exchanged for money or cryptocurrency or other item of value. In some embodiments, other criteria may need to be satisfied to convert the token to items of value. In some embodiments, the cryptocurrency or tokens could be unique to individuals or groups of individuals such that there are multiple types of cryptocurrency or tokens on the marketplace.

In one or more embodiments instead of money, cryptocurrency, or another item of value used for bounties or vouch payments, a contractual agreement or similar arrangement may serve as a substitute for the item of value. In one or more embodiments, in such a case, the agreement may provide that a token or item of value need only be transferred if the service condition is satisfied or not, as applicable (rather than up front).

In one or more embodiments, recommenders throughout the marketplace or for particular projects may be limited by the marketplace, the service buyer for the project, or some other party. For example, some embodiments may provide that, in order to be a recommender, certain criteria must be satisfied either at one time or on an ongoing or periodic basis. For example, some embodiments may require the payment of a fee to be a recommender. Some embodiments may require a certain amount of bounties to have been collected by the recommender in a given period to continue as a recommender. Some embodiments may allow service buyers or the marketplace to restrict recommenders for a particular project or job to only the best-performing recommenders as judged by some past performance criteria or by some other criteria by, for example, paying a premium. In some embodiments, the service buyer could specify that only particular recommenders that the service buyer chooses are eligible to provide a recommendation for the project. In some embodiments, recommenders may be limited to individuals or subsets of individuals that are connected to the buyer on a social network. These are just some examples of restrictions that could be place and/or criteria that need to be satisfied to serve as a recommender eligible for bounties on either a particular project, a subset of the marketplace, or the marketplace as a whole.

In some embodiments, in addition to information customarily available on websites and/or provided in resumes/CVs with respect to a service provider's skills and expertise, profile pages or other pages would include other data and information related to the invention. For example, in some embodiments, service provider profile pages could include average/aggregate ratings data generated from the system and data on vouch payments put up by recommenders and bounties paid by service buyers for projects and jobs potentially subcategorized by different specialties or other subdivisions. In addition, in one or more embodiments, detailed information on past projects and individual recommendation and vouch payments could be included. This data could also be subcategorized based on particular job classifications and average ratings could be determined algorithmically, whereby certain ratings are given more or less weight due to various factors in determining the average rating for the service provider. For example, the weight a rating is given in determining the applicable average for the service provider (including project sub-category averages and/or sub-category averages with respect to ratings, and/or other sub-categories) could depend on the overall pay of project, the length of the project, the time elapsed since project completion, and/or other factors with respect to the project and/or rater. It is further contemplated that a service provider could have multiple profiles and/or sub-profiles such as, for example, if such service provider performs projects more than one category/sub-category and projects within that category/sub-category will be used to determine average/aggregate sub-category data.

The ratings methodology used by the service buyer to rate performance can take on various forms, including percentile scores, numerical scores on a scale, alphabetical grades, stars, yes/no or recommend/decline, or any other form. Similarly, recommendations can take various forms, and there may be different scales or other methods to specify the degree of recommendation, which also may be used, for example, to determine the proportion of bounty received by the recommender upon satisfaction of the service condition.

It is contemplated that in some embodiments some or all of service provider profile information, such as some or all of the average ratings data applicable to a service provider, will be broadly accessible to individuals who access the website, while other information will only be accessible to the service buyer for a project (such as project-specific information and ratings) and other information will only be accessible to the service provider or one or more other individuals the marketplace. Similarly, in some embodiments, it is contemplated that some or all the project information will be broadly accessible to individuals who access the website, while other information will only be accessible to the project creator and/or service providers working on a project or one or more other individuals on the marketplace. In addition, it is contemplated that some information may only be accessible to recommenders and/or to a subset of such individuals who satisfy certain criteria. In one or more embodiments, the identity of the applicants or some or all information about bids may not be broadly available or may be restricted to a subset of individuals on the marketplace.

It is also contemplated that, in addition to individuals recommending particular bids, in some embodiments the system might automatically suggest service providers or particular bids for the project to the project creator and/or otherwise flag service providers that appear to be a good match for a project or job at the time of project creation or job posting (taking into account all relevant data, particularly as the system gets more robust with more detailed service provider profiles) and more extensive past project data (including similarities in scope and expertise required in the current project as compared to other past projects and/or comparison of highly-rated service providers for similar past projects), so that the project creator can potentially contact some or all of these service providers to determine if one or more would be interested in the project. Similarly, in some embodiments it is contemplated that the system will automatically suggest projects to service providers, taking into account service provider data and project data (including past project history of the service provider, such as similarities in scope and expertise of the open projects compared to projects completed by the service provider and/or projects for which the service provider received high ratings).

In one or more embodiments, it is contemplated that some or all of the information with respect to transactions on the marketplace, ratings information, information on service buyers and service buyers, fees and potential escrow of payments, and contractual terms and conditions between the service buyer and service provider, information on bounties, project or job information, and other information and data generated under the invention may be stored in a blockchain, other distributed ledger, or other medium, either together with or separate from any cryptocurrency used to pay for bounties or otherwise used on the marketplace.

In one or more embodiments, instead of the bounty being paid out depending on the rating provided by the service buyer after project completion, the bounty could be paid out to recommenders of the bid or candidate that got selected only if the bid or candidate satisfy some other performance criteria. In one or more embodiments, this performance criteria could be whether or not the individual is still working on the project or job after a specified period (such as, for example, six months or a year after hiring through the marketplace). For both projects and jobs, other performance criteria besides rating received or continued employment after a set amount of time could be used to determine whether or not the bounty is disbursed. In some embodiments, certain financial targets or other targets may be used as the measure as to whether the performance criteria is satisfied. In one or more embodiments, the service buyer or other individual would have the ability to determine what the performance criteria or other milestone is that must be met in order for the bounty to be disbursed. In addition, in some embodiments, bounties could be paid out in installments or partial bounties could be paid out periodically or, for example, if interim performance criteria are satisfied. For example, even for projects, the performance criteria could be such that the bounty is disbursed in installments if the service buyer wants the service provider to continue to work on the project after a specified elapsed time or other measurement, such as, for example, after a specified number of hours worked. In some embodiments, instead of being otherwise distributed, some or all of the bounty may be returned to the service buyer if performance criteria are not met. In addition, in one or more embodiments, vouch payments could be weighted depending on a variety of factors, such as past recommender performance or some other metric and such weighting could be used to determine the portion of the bounty the recommender is entitled to.

In one or more embodiments, the determination as to whether the performance criteria is met to disburse the bounty to recommenders may be made by somebody other than the service buyer or there may be a means to dispute the initial determination made by the service buyer. In some embodiments, this determination may be made by an arbitrator, another third party, the marketplace, or a collection of individuals on the marketplace. In one or more embodiments, it may be possible to objectively determine whether the performance criteria is met. In one or more embodiments, the performance criteria might be set forth in contract potentially on a blockchain or otherwise.

The present invention has been described in terms of specific embodiments incorporating details to facilitate the understanding of principles of construction and operation of the invention. The description herein is not intended to be exhaustive or to limit the invention to the precise forms disclosed. Thus, for example, even though service buyers, service providers, and recommenders are generally described as individuals herein, it is contemplated that each can instead be groups of individuals or entities. Similarly, even though the invention is generally described as applying to discrete projects herein, it is contemplated that this invention can also apply to longer-term jobs (and any reference to a project or job should be read to also apply in other embodiments to a job or project, respectively, even if not specifically so stated). In addition, the invention also encompasses requests for service providers or products without an entirely pre-defined project or product scope. For example, one or more embodiments of the invention encompass a request for a service provider such as, but not limited to, a plumber, doctor, lawyer, consultant, or contractor, regardless of whether substantial details of the project scope are provided. In one or more embodiments, this request can be made using a social network or portion thereof.

Furthermore, while the present invention is described primarily in terms of services, it is contemplated that this invention can apply to goods or a combination of goods and services as well, such as, for example, an item at a store either online or offline, a restaurant meal, or a travel or vacation package. For example, restaurants and/or buyers (or groups of restaurants or buyers) may provide bounties and/or recommenders may recommend a restaurant (with or without a vouch payment) and if the buyer chooses that restaurant and provides a rating after the meal above a certain threshold, the recommenders may receive a share of the bounty. In this example, if the restaurant is chosen but the threshold is not met, the bounty may otherwise be disbursed. As another example, a service buyer may offer a bounty to recommenders to recommend what car the service buyer should buy and from what dealer or other seller, potentially permitting dealers to place specific bids. As other examples, an individual may provide a bounty to their social network for a restaurant recommendation, travel recommendation, or honeymoon package recommendation. Furthermore, as another example, a service provider could include an individual on a match-making or dating website.

A number of details regarding RFPs, applications, bids, and other means of applying or expressing interest for a job or project or the marketplace, or for requesting recommendations, products, or providers, generally have not been described in detail herein, but are encompassed by embodiments of the invention. For example, bids or applications could include a variety of information regarding the work to be performed, expertise, and salary or fee information. In some embodiments, some or all of this information may be broadly viewable by others on the marketplace and some information may be restricted to a subset of individuals. In addition, other details regarding fee structures and commissions charged by the marketplace, such as potential commissions on salaries or fees paid by the buyer to the seller are not described herein. The use of the terms “bids”, “applications” or similar terms are not meant to be limiting, and encompass a variety of methods of expressing interest, applying, or submitting a proposal for a job, project, RFP, or other opening or listing. Similarly, the use of the terms “products” or “providers” are not meant to be limiting, and could encompass, for example, groups of products or providers, and providers could include individuals without a specifically defined service, such as, for example, an individual on a dating website or service provider website.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In one or more embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

The system can comprise, in whole or in part, a social-networking system. A social-networking system may enable its users (such as persons or organizations) to interact with the system and with each other. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services to facilitate social interaction between or among users.

While the disclosure has generally been described in relation to a website on the Internet, this disclosure contemplates any suitable network. As an example and not by way of limitation, one or more portions of network may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network may include one or more networks.

It will be readily apparent to one skilled in the art that other various modifications may be made to the embodiments chosen for illustration without departing from the spirit and scope of the invention.

The foregoing specification is described with reference to specific exemplary embodiments thereof. Various embodiments and aspects of the disclosure are described with reference to details discussed herein. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the present disclosure is, therefore, indicated by the appended claims rather than by the foregoing description. All changes that come within the meaning and range of equivalency of the claims are to be embraced within their scope.

From the description above, a number of advantages of some embodiments of the invention become evident including (but not limited to), separating good applications, providers, products, or bids from bad applications, providers, products, bids (based on all information available to the crowd of recommenders or potential recommenders, including non-publicly available information that potentially only a limited number of recommenders may possess). In one more embodiments, another advantage is that the system encourages the crowd of recommenders (or potential recommenders) to reach out to their networks of colleagues and other individuals they know to apply or bid for an opening or position, thereby enabling the project, job, or other buyer to reach a wider pool of potential candidates or bidders. In one or more embodiments, the crowd is incentivized to not only encourage applications by the best candidates, but also to provide a vouch or surety payment that reflects the level of confidence recommenders have in an application. These are just a just some of the potential advantages of one or more embodiments.

The invention claimed is:

1. A computer-implemented method whereby something of value (bounty) is offered in connection with a request for proposal (RFP), provider request, recommendation request, product request, or project or job listing, and such bounty or portion thereof is rewarded to some or all recommenders who recommend the proposal, individual, bid, candidate, provider, or product that is ultimately selected by the buyer if one or more criteria are satisfied.

2. The computer-implemented method of claim 1; further comprising a method whereby something of value (vouch payment) is offered by recommenders in conjunction with a recommendation of a proposal, individual, bid, candidate, provider, or product.

3. The computer-implemented method of claim 2; whereby the bounty is split by the recommenders who vouch for the selected proposal, individual, bid, candidate, provider, or product if a performance condition is satisfied.

4. The computer-implemented method of claim 3; whereby the bounty is split in proportion to the vouch payments made by recommenders who vouched for the selected proposal, individual, bid, candidate, provider, or product upon satisfaction of the performance condition.

5. A system for providing a marketplace comprising:
a. a processor; and
b. an application executed by the processor, the application configured to:
i. provide for bounties in connection with RFPs, provider requests, recommendation requests, product requests, or project or job listings;
ii. enable recommenders to recommend proposals, individuals, bids, candidates, providers, or products for the listings;
iii. enable recommenders to submit something of value along with their recommendations;
iv. enable some or all of the recommenders to receive a portion of the bounty according to some criteria.

6. A computer-implemented method for a marketplace whereby recommenders of applicants, individuals, bids, goods, services, proposals, products, or providers offer something of value in conjunction with their recommendations.

7. The computer-implemented method of claim 6; further comprising a system whereby applicants, individuals, bids, goods, services, proposals, products, or providers are ranked according to the total amount of value (or some subset or weighting of such value) offered by recommenders in conjunction with recommendations of such applicants, individuals, bids, goods, services, proposals, products, or providers.
